(19) United States
(12) Patent Application Publication
(10) Pub. No.: US 2019/0188317 A1
(43) Pub. Date: Jun. 20, 2019

(54) AUTOMATIC SEEDING OF AN APPLICATION PROGRAMMING INTERFACE (API) INTO A CONVERSATIONAL INTERFACE

(71) Applicant: INTERNATIONAL BUSINESS MACHINES CORPORATION, Armonk, NY (US)

(72) Inventors: Sujatha Kashyap, Austin, TX (US); Jan Simon Rellermeyer, Austin, TX (US); Eric Rozner, Austin, TX (US); Jeremy D. Schaub, Austin, TX (US)

(21) Appl. No.: 15/843,119

(22) Filed: Dec. 15, 2017

(51) Int. Cl. G06F 17/30; G06N 99/00

(52) U.S. Cl. CPC G06F 17/30684; G06N 99/005

(57) ABSTRACT

Systems, methods, and computer-readable media for automatically seeding an API into a natural language conversational interface are described herein. An API is automatically seeded into a natural language conversational interface by mapping a set of API calls to a set of intents, mapping the set of intents to a collection of example utterances, and using the collection of example utterances as input training data to train a natural language classifier. The trained classifier may then be used to determine an intent associated with a received query such that an action associated with the determined intent can then be performed.

### BACKGROUND

An application programming interface (API) can be a set of subroutine definitions, protocols, tools, or the like for building application software. More generally, an API is a set of clearly defined methods of communication between various software components. An API can provide the building blocks for developing a computer program in the form of an API specification which may include routines, data structures, object classes, variable, remotes calls, and so forth. Existing APIs, however, suffer from various drawbacks, technical solutions to at least some of which are described herein.

### SUMMARY

In one or more example embodiments, a method for seeding an application programming interface into a conversational interface is disclosed. The method includes utilizing a knowledge base to automatically map API calls to a set of intents, automatically mapping the set of intents to example utterances, and training a natural language classifier using the example utterances as input training data.

In one or more other example embodiments, a system for seeding an application programming interface into a conversational interface is disclosed. The system includes at least one memory storing computer-executable instructions and at least one processor configured to access the at least one memory and execute the computer-executable instructions to perform a set of operations. The operations include utilizing a knowledge base to automatically map API calls to a set of intents, automatically mapping the set of intents to example utterances, and training a natural language classifier using the example utterances as input training data.

In one or more other example embodiments, a computer program product for seeding an application programming interface into a conversational interface is disclosed. The computer program product includes a non-transitory storage medium readable by a processing circuit, the storage medium storing instructions executable by the processing circuit to cause a method to be performed. The method includes utilizing a knowledge base to automatically map API calls to a set of intents, automatically mapping the set of intents to example utterances, and training a natural language classifier using the example utterances as input training data.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic hybrid data flow/block diagram illustrating automatic seeding of an API into a natural language conversational interface in accordance with example embodiments.

FIG. 2 is a process flow diagram of an illustrative method for automatically seeding an API into a natural language conversational interface in accordance with one or more example embodiments.

FIG. 3 is a process flow diagram of an illustrative specific implementation for automatically seeding an API into a natural language conversational interface in accordance with one or more example embodiments.

FIG. 4 is a schematic diagram of an illustrative networked architecture configured to implement one or more example embodiments.

### DETAILED DESCRIPTION

Example embodiments include, among other things, systems, methods, computer-readable media, techniques, and methodologies for automatically seeding an API into a natural language conversational interface. More specifically, in accordance with example embodiments, an API is automatically seeded into a natural language conversational interface by mapping a set of API calls to a set of intents, mapping the set of intents to a collection of example utterances, and using the collection of example utterances as input training data to train a natural language classifier. The trained classifier may then be used to determine an intent associated with a received query such that an action associated with the determined intent can then be performed.

In certain example embodiments, a knowledge base may be accessed to identify API calls and associated intents as well as descriptions that describe actions to be taken based on the intents, which can be used to identify sample utterances. A variety of types of knowledge bases may be accessed. For example, documentation associated with an API such as an API specification, help documentation, or the like may serve as the knowledge base. As another non-limiting example, code examples may serve as the knowledge base. The code examples may include API calls and corresponding natural language descriptions. The code examples may be mined and sanitized to identify pairings of API calls and corresponding natural language descriptions to generate training data that may be used to train the classifier. As yet another non-limiting example, code repositories may serve as the knowledge base. Such code repositories may include numerous API usage examples, and the repositories can be mined for code that includes API calls. A model may then be constructed that analyzes code comments located in the code in proximity to API calls and generates sample utterances from the code comments. It should be appreciated that the above examples of knowledge bases are merely illustrative and not exhaustive.

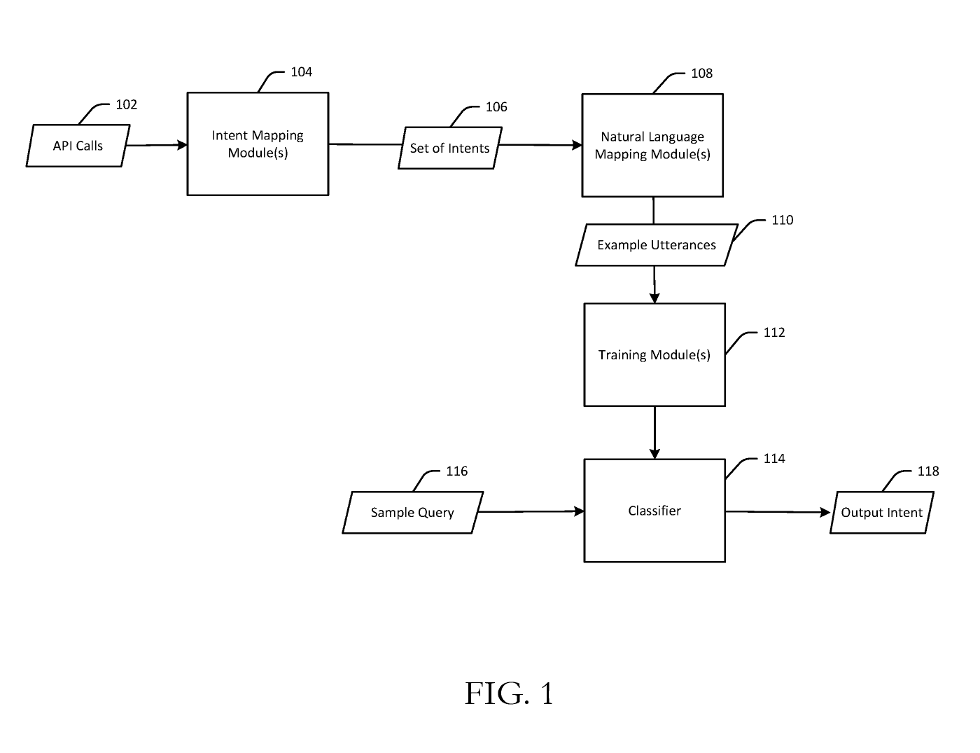

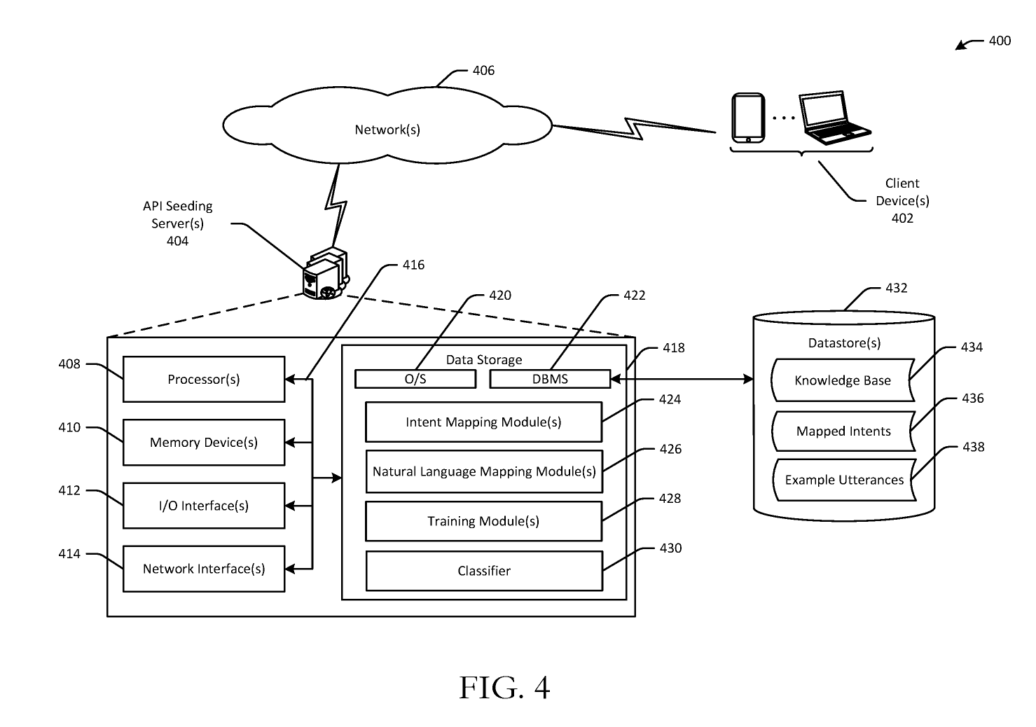

Various illustrative methods of the disclosure and corresponding data structures associated therewith will now be described. It should be noted that each operation of the methods 200 or 300 may be performed by one or more of the program modules or the like depicted in FIG. 1 or 4, whose operation will be described in more detail hereinafter. These program modules that may be implemented in any combination of hardware, software, and/or firmware. In certain example embodiments, one or more of these program modules may be implemented, at least in part, as software and/or firmware modules that include computer-executable instructions that when executed by a processing circuit cause one or more operations to be performed. A system or device described herein as being configured to implement example embodiments may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

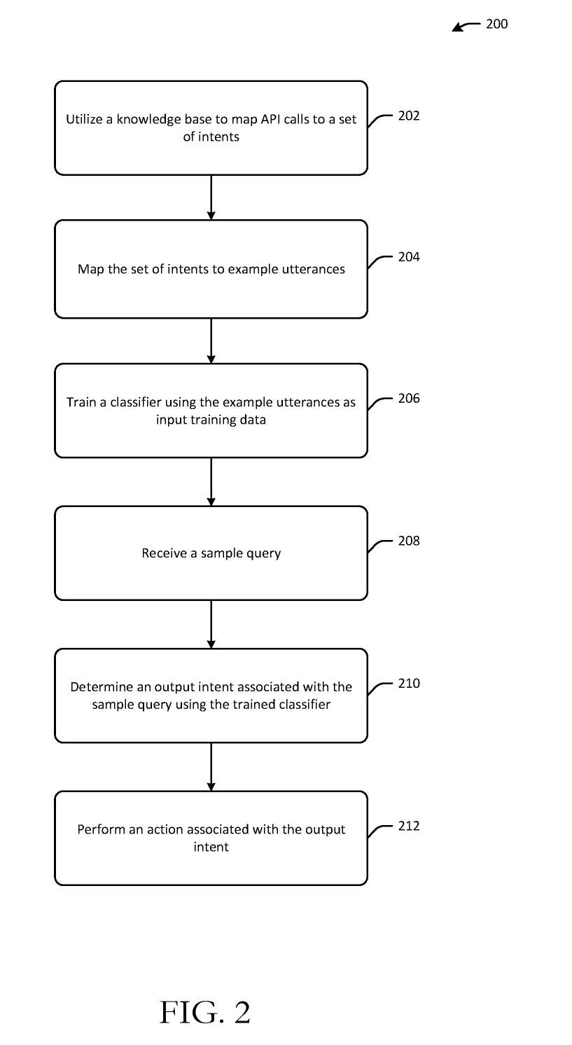

FIG. 1 is a schematic hybrid data flow/block diagram illustrating automatic seeding of an API into a natural language conversational interface. FIG. 2 is a process flow diagram of an illustrative method 200 for automatically seeding an API into a natural language conversational interface. FIG. 2 will be described in conjunction with FIG. 1 hereinafter.

Referring first to FIG. 2 in conjunction with FIG. 1, at block 202 of the method 200, computer-executable instructions of one or more intent mapping modules 104 may be executed to map API calls 102 to a set of intents 106. More specifically, computer-executable instructions of the intent mapping module(s) 104 may be executed to access a knowledge base to identify the API calls 102 and to further identify the set of intents 106 to be mapped to the API calls 102. Then, at block 204 of the method 200, computer-executable instructions of one or more natural language mapping modules 108 may be executed to map the set of intents 106 to a collection of example utterances 110.

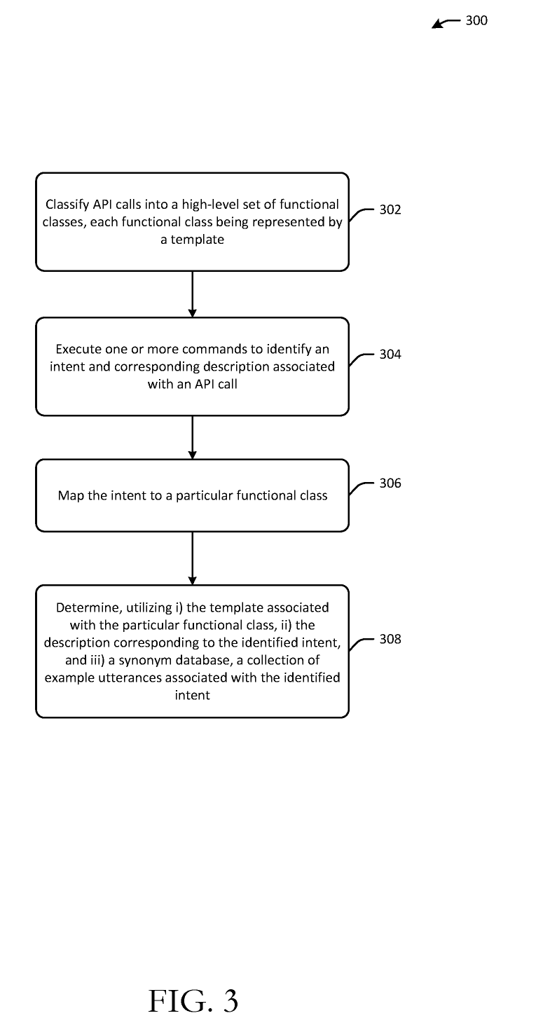

As previously described, the knowledge base may be, for example, documentation associated with an API (e.g., an API specification, help documentation, etc.). Within the API documentation, various API calls may be defined. Natural language descriptions of the actions performed in response to the API calls may be provided in association with the API call definitions. As a non-limiting example, API documentation may include the example API call “create(Container).” The natural language description “Create a new container” may be provided in association with the API call. In this example, an intent may be mapped to the “create(Container)” API call, and the intent may be further mapped to the natural language description “Create a new container,” which may be selected as an example utterance. An intent may refer to a desired goal, purpose, or action that is expressed in user input to a natural language conversational interface (e.g., a user utterance). An intent may be linked to a corresponding API call for initiating the desired goal, purpose, or action. Non-limiting examples of intents include turning on smart lights, ordering food for delivery, paying a bill, and so forth. As will be described in more detail in reference to FIG. 3, a synonym database may be employed to generate additional example utterances that map to the identified intent using the example utterance “Create a new container” taken directly from the API documentation.

Referring again to FIG. 2, at block 206 of the method 200, computer-executable instructions of one or more training modules 112 may be executed to train a classifier 114 using the collection of sample utterances 110 as input training data. Then, at block 208 of the method 200, a sample query 116 may be received. The sample query 116 may be, for example, a voice-based or text-based natural language query/request provided to a natural language conversational interface such as a chatbot, a digital assistant, or the like.

At block 210 of the method 200, computer-executable instructions of the trained classifier 114 may be executed to parse the sample query 116 and determine an output intent 118 corresponding to the query 116. More specifically, the trained classifier 114—having been trained using the collection of example utterances 110—may analyze the query 116 to determine the corresponding intent 118. In certain example embodiments, training of the classifier 114 may enable it to determine the correct intent 118 even if the query 116 does not exactly match any of the example utterances corresponding to the intent that were used as training data. Finally, at block 212 of the method 200, an action associated with the output intent 118 may be performed. For example, if the query 116 is “generate a container,” the classifier 114 may determine that this utterance corresponds to the intent to create a container and may then make the corresponding API call “create(Container).”

FIG. 3 is a process flow diagram of an illustrative specific implementation 300 for automatically seeding an API into a natural language conversational interface in which documentation associated with an API (e.g., an API specification, help documentation, etc.) is utilized as the knowledge base. FIG. 3 will be described in conjunction with FIG. 1 hereinafter.

At block 302 of the method 300, computer-executable instructions of the intent mapping module(s) 104 may be executed to classify the API calls 102 into a high-level set of functional classes. Each functional class may be represented by a context-free grammar (e.g., a template). For example, the API calls 102 may be classified into the example functional classes “create,” “read,” “update,” “delete,” “detail,” “list,” and so forth. As previously noted, the API calls 102 may be identified from documentation associated with an API.

At block 304 of the method 300, the intent mapping module(s) 104 may execute one or more commands to identify an intent and a corresponding description associated with an API call 102. For example, the intent mapping module(s) 104 may execute help commands or the like to access help documentation associated with the API. Such documentation may identify API calls defined by the API specification and may include significant natural language information corresponding to the defined API calls. Then, at block 306 of the method 300, the intent mapping module(s) 104 may map the intent identified at block 304 to a particular functional class in the set of functional classes. In certain example embodiments, in addition to the intent and the corresponding natural language description, parameters associated with the intent may also be identified. For instance, if the intent is to create a virtual machine, the parameters may include the number of processors for the virtual machine, the amount of memory to be allocated to the virtual machine, and so forth.

Referring again to the non-limiting example introduced earlier, based on executing the command(s) at block 304, the intent mapping module(s) 104 may identify an intent associated with the API call “create(Container)” at block 304, and may map that intent to the functional class “create” at block 306. In certain example embodiments, the API call (and thus the corresponding intent) may not exactly match the functional class into which the intent is classified. For example, the API call may be generate(Container), but may nonetheless be mapped to the closest functional class “create.”

At block 308 of the method 300, computer-executable instructions of the natural language mapping module(s) 108 may be executed to determine, utilizing i) the template associated with the particular functional class into which the intent has been mapped, ii) the natural language description corresponding to the identified intent, and iii) a synonym database, a set of example utterances associated with the identified intent. More specifically, the natural language mapping module(s) 108 may feed the identified intent and the sample utterance (e.g., the natural language description corresponding to the identified intent) into the template corresponding to the particular functional class into which the identified intent has been classified. The template may then determine additional example utterances for the intent using a synonym database or the like. After block 308 of the method 300, block 206 of the method 200 may be performed, where computer-executable instructions of the training module(s) 112 may be executed to train the classifier 114 using, at least in part, the set of example utterances determined at block 308 as training data.

As a non-limiting example of what a template may look like and how synonym expansion may work for a specific functional class, consider the example “create” functional class. For this functional class, the template may take the form of a tuple: [verb] [adjective] [noun]. It should be appreciated that a functional class can contain many such templates. As previously described, a “create” from a create(container) API call in a knowledge base can be used to map that API call to the create template. Then, the term “create” can be assigned to the [verb] in the template, “new” can be assigned as the [adjective], and “container” can be assigned as the [noun]. The synonym database can then be used to replace the [verb] with other synonymous terms to generate the additional example utterances. For example, the example utterance “create a new container” could spawn additional example utterances such as “initialize a new container” or “give me a new container.” The [adjective] and [noun] fields in the template may be similarly replaced through synonym expansion to yield further example utterances.

It should be appreciated that blocks 304-308 may be repeated for each API call 102 to ultimately obtain the collection of example utterances 110 used to train the classifier 114. It should further be appreciated that different knowledge bases may be used other than the API documentation described in connection with the method 300. For example, as previously described, code examples and/or actual code in code repositories may serve as the knowledge base in lieu of, or in addition to, the API documentation. In certain example embodiments, if analysis of code examples and/or actual code in code repositories does not yield a sufficient number of example utterances, the API documentation may be accessed to identify additional example utterances using synonym expansion.

Example embodiments of the disclosure provide various technical features, technical effects, and/or improvements to computer technology that solve various technical problems associated with APIs. In particular, existing APIs suffer from the technical problem of having to rely on a manual identification of sample utterances to convert the API into a natural language conversational interface. This is a time-consuming and error-prone process that may ultimately be unreliable. More specifically, existing APIs may be unable to correctly map an intent to utterances that a user may employ if a suitable number and/or variety of sample utterances are not identified.

Example embodiments of the disclosure provide the technical effect of automatically seeding an API into a conversational interface such that a trained classifier can accurately identify intents corresponding to queries by a user, while avoiding the need to manually identify sample utterances for training the classifier, and thereby obviating the technical problem identified above associated with conventional mechanisms. This technical effect is achieved at least in part by the technical feature of automatically identifying the example utterances to be used to train the classifier from analysis of one or more knowledge bases (e.g., API documentation, code examples, actual code, etc.) and mapping the example utterances to corresponding intents. The technical effect may be further achieved at least in part by the technical feature of mapping the identified intents to corresponding API calls. In addition, the technical effect may be additionally achieved by performing synonym expansion to generate additional sample utterances from a sample utterance identified from a knowledge base. The above-described technical features and their corresponding technical effect yield an improvement to computer technology for converting an API into a conversational interface.

Example embodiments also yield a number of additional technical benefits. For instance, the automatic mapping of intents to API calls and the automatic mapping of utterances to intents can be performed dynamically as new APIs are deployed or as existing APIs are changed. In addition, the processes described herein for automatically seeding an API into a conversational interface may be periodically updated and refined as more data becomes available. For example, the collection of sample utterances used to train a classifier may be periodically updated to include additional utterances, thereby refining the classifier.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

FIG. 4 is a schematic diagram of an illustrative networked architecture 400 configured to implement one or more example embodiments of the disclosure. For example, in the illustrative implementation depicted in FIG. 4, the networked architecture 400 includes one or more user devices 402 and one or more API seeding servers 404. The user device(s) 402 may include any suitable user device such as, for example, a personal computer (PC), a tablet, a smartphone, a wearable device, a voice-enabled device, or the like. In certain example embodiments, the user device(s) 402 may provide a natural language conversational interface (e.g., a voice-based interface, a text-based interface, etc.) via which a user can initiate API calls. While any particular component of the networked architecture 400 may be described herein in the singular (e.g., a API seeding server 404 or simply a server 404), it should be appreciated that multiple instances of any such component may be provided, and functionality described in connection with a particular component may be distributed across multiple ones of such a component.

The server(s) 404 and the user device(s) 402 may be configured to communicate via one or more networks 406. The network(s) 406 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 406 may have any suitable communication range associated therewith and may include, for example, global networks (e.g., the Internet), metropolitan area networks (MANs), wide area networks (WANs), local area networks (LANs), or personal area networks (PANs). In addition, the network(s) 406 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof

In an illustrative configuration, the server 404 may include one or more processors (processor(s)) 408, one or more memory devices 410 (generically referred to herein as memory 410), one or more input/output (“I/O”) interface(s) 412, one or more network interfaces 414, and data storage 418. The server 404 may further include one or more buses 416 that functionally couple various components of the server 404.

The bus(es) 416 may include at least one of a system bus, a memory bus, an address bus, or a message bus, and may permit the exchange of information (e.g., data (including computer-executable code), signaling, etc.) between various components of the server 404. The bus(es) 416 may include, without limitation, a memory bus or a memory controller, a peripheral bus, an accelerated graphics port, and so forth. The bus(es) 416 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 410 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 410 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 410 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 418 may include removable storage and/or non-removable storage including, but not limited to, magnetic storage, optical disk storage, and/or tape storage. The data storage 418 may provide non-volatile storage of computer-executable instructions and other data. The memory 410 and the data storage 418, removable and/or non-removable, are examples of computer-readable storage media (CRSM) as that term is used herein.

The data storage 418 may store computer-executable code, instructions, or the like that may be loadable into the memory 410 and executable by the processor(s) 408 to cause the processor(s) 408 to perform or initiate various operations. The data storage 418 may additionally store data that may be copied to memory 410 for use by the processor(s) 408 during the execution of the computer-executable instructions. Moreover, output data generated as a result of execution of the computer-executable instructions by the processor(s) 408 may be stored initially in memory 410 and may ultimately be copied to data storage 418 for non-volatile storage.

More specifically, the data storage 418 may store one or more operating systems (O/S) 420; one or more database management systems (DBMS) 422 configured to access the memory 410 and/or one or more external datastores 432; and one or more program modules, applications, engines, managers, computer-executable code, scripts, or the like such as, for example, intent mapping module(s) 424, natural language mapping module(s) 426, training module(s) 428, and a classifier 430. Any of the components depicted as being stored in data storage 418 may include any combination of software, firmware, and/or hardware. The software and/or firmware may include computer-executable instructions (e.g., computer-executable program code) that may be loaded into the memory 410 for execution by one or more of the processor(s) 408 to perform any of the operations described earlier in connection with correspondingly named modules.

Although not depicted in FIG. 4, the data storage 418 may further store various types of data utilized by components of the server 404 (e.g., any of the data depicted as being stored in one or more external datastore(s) 432). Any data stored in the data storage 418 may be loaded into the memory 410 for use by the processor(s) 408 in executing computer-executable instructions. In addition, any data stored in the data storage 418 may potentially be stored in the external datastore(s) 432 and may be accessed via the DBMS 422 and loaded in the memory 410 for use by the processor(s) 408 in executing computer-executable instructions.

The processor(s) 408 may be configured to access the memory 410 and execute computer-executable instructions loaded therein. For example, the processor(s) 408 may be configured to execute computer-executable instructions of the various program modules, applications, engines, managers, or the like of the server 404 to cause or facilitate various operations to be performed in accordance with one or more embodiments of the disclosure. The processor(s) 408 may include any suitable processing unit capable of accepting data as input, processing the input data in accordance with stored computer-executable instructions, and generating output data. The processor(s) 408 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 408 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 408 may be capable of supporting any of a variety of instruction sets.

Referring now to other illustrative components depicted as being stored in the data storage 418, the 0/S 420 may be loaded from the data storage 418 into the memory 410 and may provide an interface between other application software executing on the server 404 and hardware resources of the server 404. More specifically, the O/S 420 may include a set of computer-executable instructions for managing hardware resources of the server 404 and for providing common services to other application programs. In certain example embodiments, the 0/S 420 may include or otherwise control execution of one or more of the program modules, engines, managers, or the like depicted as being stored in the data storage 418. The 0/S 420 may include any operating system now known or which may be developed in the future including, but not limited to, any server operating system, any mainframe operating system, or any other proprietary or non-proprietary operating system.

The DBMS 422 may be loaded into the memory 410 and may support functionality for accessing, retrieving, storing, and/or manipulating data stored in the memory 410, data stored in the data storage 418, and/or data stored in external datastore(s) 432. The DBMS 422 may use any of a variety of database models (e.g., relational model, object model, etc.) and may support any of a variety of query languages. The DBMS 422 may access data represented in one or more data schemas and stored in any suitable data repository. Data stored in the datastore(s) 432 may include, for example, knowledge base data 434, mapped intents data 436, and example utterance data 438. External datastore(s) 432 that may be accessible by the server 404 via the DBMS 422 may include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the server 404, the input/output (I/O) interface(s) 412 may facilitate the receipt of input information by the server 404 from one or more I/O devices as well as the output of information from the server 404 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server 404 or may be separate. The I/O devices may further include, for example, any number of peripheral devices such as data storage devices, printing devices, and so forth.

The I/O interface(s) 412 may also include an interface for an external peripheral device connection such as universal serial bus (USB), FireWire, Thunderbolt, Ethernet port or other connection protocol that may connect to one or more networks. The I/O interface(s) 412 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The server 404 may further include one or more network interfaces 414 via which the server 404 may communicate with any of a variety of other systems, platforms, networks, devices, and so forth. The network interface(s) 414 may enable communication, for example, with one or more other devices via one or more of the network(s) 406.

It should be appreciated that the program modules/engines depicted in FIG. 4 as being stored in the data storage 418 are merely illustrative and not exhaustive and that processing described as being supported by any particular module may alternatively be distributed across multiple modules, engines, or the like, or performed by a different module, engine, or the like. In addition, various program module(s), script(s), plug-in(s), Application Programming Interface(s) (API(s)), or any other suitable computer-executable code hosted locally on the server 404 and/or other computing devices accessible via the network(s) 406, may be provided to support functionality provided by the modules depicted in FIG. 4 and/or additional or alternate functionality. Further, functionality may be modularized in any suitable manner such that processing described as being performed by a particular module may be performed by a collection of any number of program modules, or functionality described as being supported by any particular module may be supported, at least in part, by another module. In addition, program modules that support the functionality described herein may be executable across any number of cluster members in accordance with any suitable computing model such as, for example, a client-server model, a peer-to-peer model, and so forth. In addition, any of the functionality described as being supported by any of the modules depicted in FIG. 4 may be implemented, at least partially, in hardware and/or firmware across any number of devices.

It should further be appreciated that the server 404 may include alternate and/or additional hardware, software, or firmware components beyond those described or depicted without departing from the scope of the disclosure. More particularly, it should be appreciated that software, firmware, or hardware components depicted as forming part of the server 404 are merely illustrative and that some components may not be present or additional components may be provided in various embodiments. While various illustrative modules have been depicted and described as software modules stored in data storage 418, it should be appreciated that functionality described as being supported by the modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional program modules and/or engines not depicted may be present and may support at least a portion of the described functionality and/or additional functionality.

One or more operations of the methods 200 or 300 may be performed by a server 404 having the illustrative configuration depicted in FIG. 4, or more specifically, by one or more program modules, engines, applications, or the like executable on such a device. It should be appreciated, however, that such operations may be implemented in connection with numerous other device configurations.

The operations described and depicted in the illustrative methods of FIGS. 2 and 3 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2 and 3 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for automatically seeding an application programming interface (API) into a natural language conversational interface, the method comprising:
utilizing a knowledge base to automatically map API calls to a set of intents;
automatically mapping the set of intents to example utterances; and
training a natural language classifier using the example utterances as input training data.

2. The computer-implemented method of claim 1, wherein the knowledge base comprises at least one of documentation associated with the API, code examples, or actual code stored in code repositories.

3. The computer-implemented method of claim 1, further comprising:
receiving a natural language query;
determining, using the natural language classifier, a particular intent in the set of intents that maps to the natural language query;
determining a particular API call associated with the particular intent; and
executing the particular API call to perform an action corresponding to the particular intent.

4. The computer-implemented method of claim 1, wherein utilizing the knowledge base to automatically map the API calls to the set of intents comprises:
classifying the API calls into a set of functional classes, wherein each functional class is associated with a template;
executing one or more commands to identify a particular intent and a corresponding natural language description associated with a particular API call; and
mapping the particular intent to a particular functional class in the set of functional classes.

5. The computer-implemented method of claim 4, wherein automatically mapping the set of intents to the example utterances comprises determining, utilizing i) a particular template associated with the particular functional class, ii) the natural language description, and iii) a synonym database, a subset of the example utterances used to train the natural language classifier, wherein the subset of the example utterances corresponds to the particular intent.

6. The computer-implemented method of claim 5, wherein the natural language description is an initial example utterance in the subset of the example utterances corresponding to the particular intent, and wherein determining the subset of the example utterances comprises performing a synonym expansion of the initial example utterance using the synonym database to identify additional example utterances in the subset.

7. The computer-implemented method of claim 1, further comprising identifying, from the knowledge base, one or more respective parameters associated with each intent in the set of intents.

8. A system for automatically seeding an application programming interface (API) into a natural language conversational interface, the system comprising:
at least one memory storing computer-executable instructions; and
at least one processor configured to access the at least one memory and execute the computer-executable instructions to:
utilize a knowledge base to automatically map API calls to a set of intents;
automatically map the set of intents to example utterances; and
train a natural language classifier using the example utterances as input training data.

9. The system of claim 8, wherein the knowledge base comprises at least one of documentation associated with the API, code examples, or actual code stored in code repositories.

10. The system of claim 8, wherein the at least one processor is further configured to execute the computer-executable instructions to:
receive a natural language query;
determine, using the natural language classifier, a particular intent in the set of intents that maps to the natural language query;
determine a particular API call associated with the particular intent; and
execute the particular API call to perform an action corresponding to the particular intent.

11. The system of claim 8, wherein the at least one processor is configured to utilize the knowledge base to automatically map the API calls to the set of intents by executing the computer-executable instructions to:
classify the API calls into a set of functional classes, wherein each functional class is associated with a template;
execute one or more commands to identify a particular intent and a corresponding natural language description associated with a particular API call; and
map the particular intent to a particular functional class in the set of functional classes.

12. The system of claim 11, wherein the at least one processor is configured to automatically map the set of intents to the example utterances by executing the computer-executable instructions to determine, utilizing i) a particular template associated with the particular functional class, ii) the natural language description, and iii) a synonym database, a subset of the example utterances used to train the natural language classifier, wherein the subset of the example utterances corresponds to the particular intent.

13. The system of claim 12, wherein the natural language description is an initial example utterance in the subset of the example utterances corresponding to the particular intent, and wherein the at least one processor is configured to determine the subset of the example utterances by executing the computer-executable instructions to perform a synonym expansion of the initial example utterance using the synonym database to identify additional example utterances in the subset.

14. The system of claim 8, wherein the at least one processor is further configured to execute the computer-executable instruction to identify, from the knowledge base, one or more respective parameters associated with each intent in the set of intents.

15. A computer program product for automatically seeding an application programming interface (API) into a natural language conversational interface, the computer program product comprising a storage medium readable by a processing circuit, the storage medium storing instructions executable by the processing circuit to cause a method to be performed, the method comprising:
utilizing a knowledge base to automatically map API calls to a set of intents;
automatically mapping the set of intents to example utterances; and
training a natural language classifier using the example utterances as input training data.

16. The computer program product of claim 15, wherein the knowledge base comprises at least one of documentation associated with the API, code examples, or actual code stored in code repositories.

17. The computer program product of claim 15, the method further comprising:
receiving a natural language query;
determining, using the natural language classifier, a particular intent in the set of intents that maps to the natural language query;
determining a particular API call associated with the particular intent; and
executing the particular API call to perform an action corresponding to the particular intent.

18. The computer program product of claim 15, wherein utilizing the knowledge base to automatically map the API calls to the set of intents comprises:
classifying the API calls into a set of functional classes, wherein each functional class is associated with a template;
executing one or more commands to identify a particular intent and a corresponding natural language description associated with a particular API call; and
mapping the particular intent to a particular functional class in the set of functional classes.

19. The computer program product of claim 18, wherein automatically mapping the set of intents to the example utterances comprises determining, utilizing i) a particular template associated with the particular functional class, ii) the natural language description, and iii) a synonym database, a subset of the example utterances used to train the natural language classifier, wherein the subset of the example utterances corresponds to the particular intent.

20. The computer program product of claim 19, wherein the natural language description is an initial example utterance in the subset of the example utterances corresponding to the particular intent, and wherein determining the subset of the example utterances comprises performing a synonym expansion of the initial example utterance using the synonym database to identify additional example utterances in the subset.
